(19) United States
(12) Patent Application Publication
(10) Pub. No.: US 2026/0230868 A1
(43) Pub. Date: Aug. 6, 2026

(54) INTERFERENCE DETERMINATION FOR DIFFERENT TIME DIVISION DUPLEXING NETWORKS

(71) Applicant: Telefonaktiebolaget LM Ericsson (publ), Stockholm (SE)

(72) Inventors: Jordi BIOSCA CARO, Aachen (DE); Luis Felipe DEL CARPIO VEGA, Espoo (FI); Junaid ANSARI, Aachen (DE); Majid GERAMI, Lund (SE); Antti RATILAINEN, Espoo (FI); Eda GENC, Espoo (FI)

(21) Appl. No.: 19/155,098

(22) PCT Filed: Feb. 16, 2023
(86) PCT No.: PCT/EP2023/053873

§ 371 Date: Aug. 8, 2025

(51) Int. Cl. H04W 24/08; H04L 5/00

(52) U.S. Cl. CPC H04W 24/08; H04L 5/0055

(57) ABSTRACT

Provided is a method for determining an interference pattern in an interfered network operating in a time division duplexing (TDD) mode. The method includes determining a count value for each of a plurality of TDD slots based on a number of non-acknowledgement (NACK) feedbacks mapped to each TDD slot. Furthermore, the method includes organizing the count values in a plurality of interference vectors having a predefined size and creating a matrix, wherein each interference vector represents a row in the matrix. The count values per column of the matrix are summed up to obtain a sum value per column and the sum values are organized in a sum vector. A NACK occurrence pattern is identified from the sum vector and the interference pattern is determined from the identified NACK occurrence pattern.

### TECHNICAL FIELD

The present invention relates to the field of interference determination. In particular, the present invention relates to a method and node for determining an interference pattern in an interfered network operating in a time division duplexing mode.

### BACKGROUND

As with cellular technology such as 3rd Generation Partnership Project (3GPP) fifth generation (5G) and future mobile communication standards (for example, sixth generation (6G)), the focus has been expanding beyond the classical mobile broadband applications. Particularly, the industry is moving towards adopting new wireless communications standards capable of handling high number of terminal devices connected to, for example, sensors, robots, controllers, mobile platforms, etc. There is a need for efficient wireless communication not only for machine-type communication but also for the interaction and collaboration between humans and machines.

For example, the 3GPP 5G standard, also called New Radio (NR), aims at enabling new manufacturing concepts to be implemented in the Industry 4.0 context. From the research point of view, many new topics and questions arise, for instance, how two or more networks in close vicinity on adjacent or co-channel spectrum would coexist and satisfy the expected Quality of Service (QoS) targets for the Industry 4.0 applications. In this respect, “adjacent spectrum” may refer to two or more networks using nearby spectrum, whereas “co-channel spectrum” may refer to two or more networks using the same or overlapping spectrum.

One of the revolutions of the 5G standard of cellular

communications has been the introduction of local licenses for 5G NR private deployments to promote innovation and facilitate the emergence of new services. With the increasing number of 5G industrial deployments in locally licensed spectrum, new technological challenges appear, for instance, the coexistence among different 5G networks. The deployment of new 5G non-public networks (NPN) especially in the mid-band frequencies in the overlapping spectrum or in adjacent channels or bands lead to spectral interference which may impact the performance characteristics of the coexisting networks.

For 5G deployments, there are two types of duplexing: frequency division duplexing (FDD) and time division duplexing (TDD). For TDD 5G deployments, the coexistence behavior between neighbor, i.e. coexisting, networks may depend upon a transmission direction, a distance between a transmitter and receiver, a number of TDD slots interfered depending upon a TDD structure, a signal strength of the actual transmission, an interfering signal, and the like.

According to the traffic direction, different types of spectral interference may occur. When two coexisting networks use the same transmission direction, a so-called near-far interference (NFI) may occur. On the other hand, when the transmission directions of the two coexisting networks are different, cross-link interference (CLI) may occur. It is noted that the spectral interference coming from cross-link interference is usually higher compared to near-far interference.

One of the key techniques to mitigate interference may be link adaptation, which governs physical resource assignment as per perceived signal to interference plus noise ratio (SINR) at the receiver.

Furthermore, an offset based on feedback from previous transmissions may be used to adjust the resource assignment used per transmission. The feedback may be hybrid automatic repeat request (HARQ) feedback and, in this case, may be based on acknowledgements (ACK) and non-acknowledgements (NACK) of previous transmissions. Every time an ACK is received, the offset may be increased, while a NACK may reduce the offset and the resulting estimated SINR may be lower. The ACK and NACK, respectively, feedback may be applicable for physical downlink shared channel (PDSCH) and physical uplink shared channel (PUSCH) transmissions. For brevity, the ACK and NACK feedback will be called ACK/NACK feedback in the following.

For PDSCH transmissions, ACK/NACK feedback may be carried via physical uplink control channels (PUCCH) or PUSCH.

For PUSCH transmissions, ACK/NACK feedback may be internally used at a network node, such as a base station (BS), gNodeB (gNB), transmission point (TRP) or the like, and corrective actions may be carried via uplink grants.

It is noted that in the case of PUSCH reception, the network node usually has more information available about the reception process, because the network node holds a receiver unit. This means that, for example, interference estimation for uplink direction is available at the network node. This is, however, not the case for PDSCH receptions. As a terminal device usually only provides ACK/NACK feedback, the network node does not have additional information about the reception process of PDSCH transmissions at the terminal device.

FIG. 1 shows an example of two neighbor, i.e. coexisting, networks for highlighting potential issues between the two coexisting networks. Network 1 may be an indoor non-public network (NPN) and network 2 may be an outdoor public network (PN). However, the networks are not restricted to being an indoor NPN and an outdoor PN and other scenarios may be applicable, as well.

FIG. 1 shows exemplary TDD patterns for network 1 and network 2. The letter “D” stands for a downlink (DL) slot, the letter “U” stands for an uplink (UL) slot, and the letter “S” stands for a special slot. In this case, the special slot is treated as a DL slot. The arrows (shown with dashed or solid lines) represent interferences on the UL slots of network 1.

A user equipment (UE) from network 2 getting close to network 1 may significantly degrade the downlink and uplink performance of network 1. The issue of interference is particularly concerning for industrial use-cases with mission critical traffic demands.

In addition, the downlink and uplink performance of network 1 may be analyzed in the presence of interference with different or unaligned TDD patterns, i.e., the TDD pattern used for network 1 is not the same as the TDD pattern used for network 2 (see FIG. 1). This is of relevance since many industrial, production, and automation applications may require a more balanced downlink/uplink TDD pattern, i.e. a rather similar uplink/downlink split in the TDD pattern, in contrast to the primarily DL oriented TDD patterns used in classical mobile broadband applications. Important to note is that according to 3 GPP 38.401 V17.3.0(2022 -12), section 9, all network nodes should preferably be time aligned and the beginning and end of all TDD slots should be time synchronized. Therefore, if coexisting networks use the same TDD pattern, there may only happen spectral interference in the same traffic direction, i.e., UL-to-UL or DL-to-DL. This may be the near-far interference described above.

However, FIG. 1 shows different, i.e. unaligned, TDD patterns for network 1 and network 2. Here, the spectral interference for such unaligned TDD patterns may be different compared to aligned TDD patterns since UL slots of network 1 may collide not only with UL slots of network 2 but also with DL slots (see the arrows with dashed lines in FIG. 1). This is similar for DL slots of network 1. Thus, cross-link interference may occur. In contrast thereto, near-far interference is illustrated in FIG. 1 with an arrow having a solid line.

Therefore, there are not only two sources of spectral interference, i.e. near-far interference and cross-link interference, in FIG. 1, but the spectral interferences may be different to every TDD slot. For instance, as observed from FIG. 1, on every TDD pattern period the spectral interference on the UL slots of network 1 comes from a different TDD slot of network 2, i.e. from a DL slot, an UL slot, or a special slot. This is of relevant importance when considering the interference, because the UL performance of network 1 may depend on the location of a UE and network node, transmission bitrate, interference sources (for example, only UL, only DL, or both) , and interference levels. Therefore, each UL slot opportunity of network 1 may suffer different interference levels.

This in turn may be relevant for a Link Adaptation (LA) algorithm, wherein the signal to interference and noise ratio (SINR) of network 1 may be quite unique for each of the slots of the TDD pattern and not only across the duration of the TDD pattern of network 1. Moreover, for an unsynchronized, i.e. unaligned, TDD pattern scenario, the interference levels may vary and distort the SINR. Hence, the assignment of a modulation and coding scheme (MCS) and resource blocks (RB) by the LA algorithm might not be very accurate. The inaccuracy of the estimated SINR by the LA algorithm may lead to either too optimistic or too pessimistic resource allocation which may significantly impact the network performance of network 1.

One of the conclusions of observing spectral interference is that interference levels may vary based on locations of the UEs, transmission bitrates, uplink or downlink transmission direction, received uplink/downlink interference and the TDD patterns. Furthermore, spatial aspects for transmissions may also influence the interference levels, like beamforming, partial blockage, shadowing, etc. While there are already some solutions which address some of these aspects, such as selecting a different block error rate (BLER) target manually per UE or choosing manually different BLER targets for uplink and downlink, there is no method able to adapt to variations and repetitive nature of the interference depending upon the specific encountered conditions as mentioned above in a dynamic manner.

### SUMMARY

It may be an object of the invention to provide techniques and methods for reducing the effect of interference in a TDD network neighboring another TDD network.

According to an aspect, a method for determining an interference pattern in an interfered network operating in a time division duplexing (TDD) mode comprises determining a count value for each of a plurality of TDD slots based on a number of non-acknowledgement (NACK) feedbacks mapped to each TDD slot. The method further comprises organizing the count values in a plurality of interference vectors having a predefined size and creating a matrix. Each interference vector represents a row in the matrix. In addition, the method comprises summing up the count values per column of the matrix to obtain a sum value per column and organizing the sum values in a sum vector. Moreover, the method comprises identifying a NACK occurrence pattern from the sum vector and determining the interference pattern from the identified NACK occurrence pattern.

According to another aspect, a node for determining an interference pattern in an interfered network operating in a TDD mode is configured to determine a count value for each of a plurality of TDD slots based on a number of NACK feedbacks mapped to each TDD slot. Furthermore, the node is configured to organize the count values in a plurality of interference vectors having a predefined size and create a matrix. Each interference vector represents a row in the matrix. Moreover, the node is configured to sum up the count values per column of the matrix to obtain a sum value per column and organize the sum values in a sum vector. In addition, the node is configured to identify a NACK occurrence pattern from the sum vector and determine the interference pattern from the identified NACK occurrence pattern.

According to another aspect, a node for determining an interference pattern in an interfered network operating in a TDD mode comprises a processor and a memory. Said memory contains instructions executable by said processor. Said node is operative to determine a count value for each of plurality of TDD slots based on a number of NACK feedbacks mapped to each TDD slot. Furthermore, said node is operative to organize the count values in a plurality of interference vectors having a predefined size and create a matrix. Each interference vector represents a row in the matrix. Moreover, said node is operative to sum up the count values per column of the matrix to obtain a sum value per column and organize the sum values in a sum vector. In addition, the node is operative to identify a NACK occurrence pattern from the sum vector and determine the interference pattern from the identified NACK occurrence pattern.

According to another aspect, a computer program comprises program code to be executed by a processor to operate a node for determining an interference pattern in an interfered network operating in a TDD mode. Execution of the program code causes the node to perform operations which comprise determining a count value for each of a plurality of TDD slots based on a number of NACK feedbacks mapped to each TDD slot. Furthermore, the operations comprise organizing the count values in a plurality of interference vectors having a predefined size and creating a matrix. Each interference vector represents a row in the matrix. Moreover, the operations comprise summing up the count values per column of the matrix to obtain a sum value per column and organizing the sum values in a sum vector. In addition, the operations comprise identifying a NACK occurrence pattern from the sum vector and determining the interference pattern from the identified NACK occurrence pattern.

According to another aspect, a computer program product comprises a non-transitory storage medium including program code to be executed by a processor to operate a node. The node is for determining an interference pattern in an interfered network operating in a TDD mode. Execution of the program code causes the node to perform operations comprising determining a count value for each of a plurality of TDD slots based on a number of NACK feedbacks mapped to each TDD slot. Furthermore, the operations comprise organizing the count values in a plurality of interference vectors having a predefined size and creating a matrix. Each interference vector represents a row in the matrix. Moreover, the operations comprise summing up the count values per column of the matrix to obtain a sum value per column and organizing the sum values in a sum vector. In addition, the operations comprise identifying a NACK occurrence pattern from the sum vector and determining the interference pattern from the identified NACK occurrence pattern.

### BRIEF DESCRIPTION OF THE DRAWINGS

FIG. 1 shows an example of two coexisting networks for highlighting potential issues between the two coexisting networks.

FIG. 2 shows an exemplary coexistence scenario depicting interference between two neighbor networks.

FIG. 3 shows an exemplary relationship between time division duplexing (TDD) slot number and hybrid automatic repeat request (HARQ) feedback collection.

FIG. 4 shows a method for determining an interference pattern in an interfered network operating in a TDD mode.

FIG. 5 shows an exemplary matrix of NACK count samples with interference vector size of two times the TDD pattern size.

FIG. 6 shows another representation of the matrix of FIG. 5.

FIG. 7 shows an exemplary matrix of NACK count samples with interference vector size of five times the TDD pattern size.

FIG. 8 shows another representation of the matrix of FIG. 7.

FIG. 9 shows an example of the previously described method with additional steps to further improve the interference pattern determination.

FIG. 10 shows an example of a matrix with interference vectors having a size of 20 TDD slots and non-continuous interference.

FIG. 11 shows an example of a simplified flowchart with feedbacks that can potentially be used for interference pattern determination.

FIG. 12 shows exemplary hardware of a node for determining an interference pattern in an interfered network operating in a TDD mode.

FIG. 13 shows an example where the node is a network node operating the interfered network.

FIG. 14 shows an example where the node is a cloud node.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

FIG. 2 shows an exemplary coexistence scenario depicting interference between two neighbor networks 210a and 220a. The two networks 210a and 220a may be called cells and may be 3GPP 5G NR networks. However, this is not limiting and the networks 210a and 220a may support any other 3GPP standard.

Network 210a is served by network node 210, wherein terminal device 230 is located in network 210a and served by network node 210. Network 210a may be an indoor NPN. Network 220a is served by network node 220, wherein terminal device 240 is located in network 220a and served by network node 220. Network 220a may be an outdoor PN. It is noted that more than two neighbor networks with one or more terminal devices may be present.

The terminal devices 230 and 240 may be any type of devices that have access to (i.e., is served by) a cellular communications network by communicating wirelessly with network nodes and/or other terminal devices. Communicating wirelessly can involve transmitting and/or receiving wireless signals using electromagnetic waves, radio waves, infrared waves, and/or other types of signals suitable for conveying information through air. The terminal devices 230 and 240 may be a wireless end device or a UE. Some examples of a terminal device include, but are not limited to smart phones, mobile phones, cell phones, voice over IP (VOIP) phones, wireless local loop phones, desktop computers, personal digital assistants (PDAS), wireless cameras, gaming consoles or devices, music storage devices, playback appliances, wearable devices, wireless endpoints, mobile stations, tablets, laptops, laptop-embedded equipment (LEE), laptop-mounted equipment (LME) , smart devices, wireless customer-premise equipment (CPE), mobile-type communication (MTC) devices, Internet-of-Things (IoT) devices, vehicle-mounted wireless terminal devices, etc. Unless otherwise noted, the term “terminal device” is used interchangeably herein with the term “wireless device”, “wireless end device”, “user equipment”, “UE”, or “terminal”.

The network nodes 210 and 220 may be radio network nodes which are any nodes that are part of the radio access network of a cellular communications network. Functionally, a network node is equipment capable, configured, arranged, and/or operable to communicate directly or indirectly with a terminal device and/or with other network nodes or equipment in the cellular communications network, to enable and/or provide wireless access to the terminal device, and/or to perform other functions (e. g., administration) in the cellular communications network. The network node may be a base station, gNodeB (gNB), or the like.

Note that the description herein focuses on a 3GPP cellular communications system and, as such, 3GPP terminology or terminology similar to 3GPP terminology is oftentimes used. However, the concepts disclosed herein are not limited to a 3GPP system.

In FIG. 2, the two networks 210a and 220a have essentially different, i.e. unaligned, TDD patterns which means that each network node 210a, 220a and each terminal device 230, 240 may experience different types of interference. For instance, when network node 210 transmits in downlink to terminal device 230, network node 210 may generate cross-link interference (CLI) to the receiver of network node 220 or near-far interference (NFI) to the receiver of terminal device 240. Similarly, if network node 220 transmits in downlink to terminal device 240, network node 220 generates cross-link interference to the receiver of network node 210 or near-far interference to the receiver of terminal device 230. In FIG. 2, the cross-link interference is shown with arrows 250, whereas the near-far interference is shown with arrows 260.

On the other hand, if terminal device 230 transmits in uplink to network node 210, near-far interference may occur to the receiver of network node 220 or cross-link interference may occur to the receiver of terminal device 240. Similarly, if terminal device 240 transmits in uplink to network node 220, near-far interference may occur to the receiver of network node 210 or cross-link interference may occur to the receiver of terminal device 210.

As described above, the network nodes may operate in a time division duplexing (TDD) mode. Here, a problem to solve is how to detect interference in different TDD slots and how to predict the future likelihood of interference being present in different TDD slots for a given network. In FIG. 2, it is assumed that network 210 is the interfered network, whereas network 220 is the interfering network. However, this is not limiting and the network 220 may be the interfered network and network 210 may be the interfering network.

Now, a method for determining an interference pattern in the interfered network operating in TDD mode will be described. The method may require statistics' collection and processing. For collecting feedback statistics, network 210 may collect feedback statistics for all transmission while the networks 210 and 220 are in operation. Hybrid automatic repeat request (HARQ) feedback statistics may be mapped to specific N slots where data radio transmission occurred and to a terminal device which has received or transmitted the radio transmission.

As explained in more detail below, an interference pattern may be determined by identifying a NACK occurrence pattern using HARQ statistics, the NACK occurrence pattern being correlated with the interference pattern.

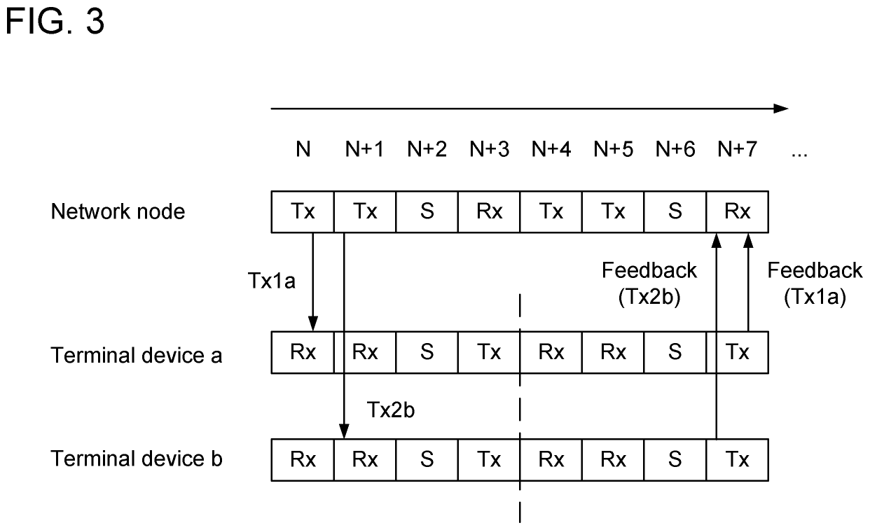

An example is given in FIG. 3. FIG. 3 shows an exemplary relationship between TDD slot number and HARQ feedback collection. The HARQ feedback is a mechanism standardized by 3GPP in order to improve the resource assignment of transmissions. HARQ statistics are usually collected in 3GPP specified systems and HARQ feedback is often used in outer loop link adaptation. The proposed method leverages from the information used in the link adaptation on ACK and NACK on a slot basis to identify the interference pattern especially for unaligned TDD networks.

In FIG. 3, two feedback transmissions are received by the network node, such as a base station, gNodeB (gNB), or the like, in slot N+7. The slot indicated by “Tx” indicates a slot where transmission occurs, whereas the slot indicated by “Rx” indicates a slot where reception occurs. “S” indicates a special slot. In FIG. 3, the network node transmits a first transmission signal Tx1a to terminal device a in slot N. Furthermore, the network node transmits a second transmission signal Tx2b to terminal device b in slot N+1.

Feedback (Tx1a) and Feedback (Tx2b) indicate feedback transmissions in response to the transmissions Tx1a and Tx2b. Feedback (Tx1a) is related to slot N and, thus, HARQ feedback statistics may map it to slot N and to terminal device a. Feedback (Tx2b) is related to slot N+1 and, thus, HARQ statistics may map it to slot N+1 and also to terminal device b. By mapping the HARQ statistics to UEs and slot number, it is possible to enrich the statistics with, for example, position information or other transmission parameters at a further processing step.

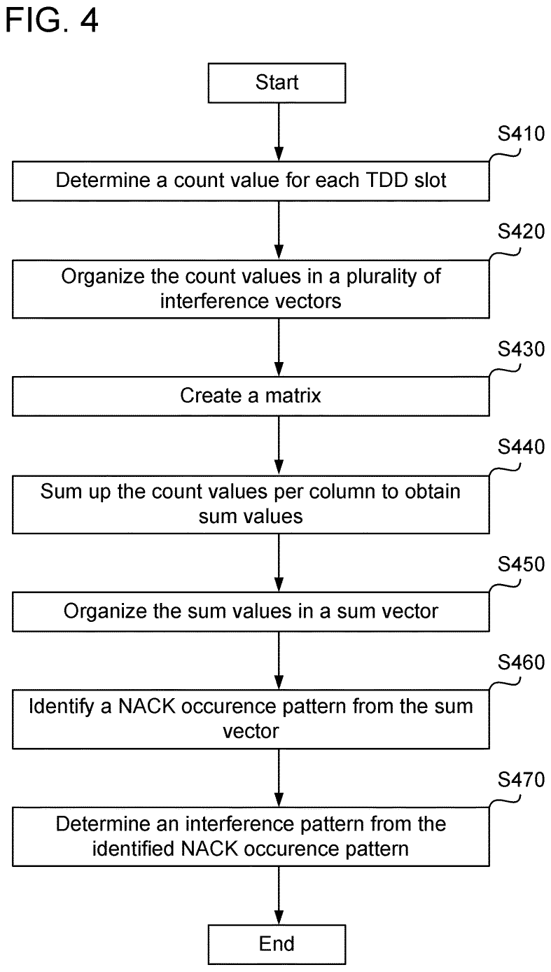

FIG. 4 shows a method for determining an interference pattern in an interfered network operating in a TDD mode. The method is about detecting NACK occurrence patterns which are highly correlated to interference patterns. Thus, interference patterns are determined or detected with high probability and accuracy in order to circumvent performance losses due to interference. The method may target static and less mobile scenarios where it may be assumed that topologies will hold for multiple packet transmissions.

The method may be implemented in a node, such as a radio network node, a core network node, another network node or cloud node, which will be described in more detail below. The method may be executed by the node when the interfered network is running and one or more terminal devices are connected to the interfered network, for example.

The interfered network has been exemplary described above with respect to FIG. 2 and may refer to a network from at least two coexisting networks. The coexisting networks may be neighbor, adjacent, or cochannel networks comprising at least one interfered network and at least one interfering network. The interfered network may experience interference from the interfering network. Both the interfered network and the interfering network may operate in a TDD mode, wherein the interfered network and the interfering network may have essentially different, i.e. unaligned, TDD patterns or frame structures. Thus, not only near-far interference but also cross-link interference may occur. Both TDD patterns may be synchronized in time and the slot boundaries may be defined by 3GPP.

As shown in FIG. 4, the method may comprise determining (step S410) a count value for each of a plurality of TDD slots based on a number of NACK feedbacks mapped to each TDD slot. The count value may be stored per terminal device transmitting NACK feedbacks.

For example, the NACK feedbacks are collected for or received in a specific time window. NACK feedbacks which are received outside of the specific time window may be omitted when determining the count value. The specific time window may be

Flexibly configured. for instance, the specific time window is determined based on a subcarrier spacing (SCS). For a higher SCS, the specific time window may be set smaller compared to a case where the SCS is lower, for example.

It is also possible to not set a specific time window. In this case, all NACK feedbacks transmitted in the past may be collected or received to determine the count value for each of the plurality of TDD slots.

The determining step may comprise estimating or calculating the count value. For example, the NACK feedbacks are summed up for each TDD slot to determine the count value. For instance, the NACK feedbacks per slot may be derived from HARQ feedbacks and may be added, i.e. summed up, to obtain the count value. When referring to FIG. 3, the number of NACK feedbacks mapped to slot N may be 1 if Feedback (Tx1a) represents a NACK. If Feedback (Tx1a) represents an ACK, the number of NACK feedbacks mapped to slot N may be 0. For slot N+1, the number of NACK feedbacks may be 1 if Feedback (Tx2b) represents a NACK or may be 0 if Feedback (Tx2b) represents an ACK. Thus, based on the collected feedback statistics, the number of NACK feedbacks mapped to each slot may be counted. The mapping to the TDD slots may be done using, for example, TDD slot identification information (ID).

Furthermore, the method may comprise organizing (step S420) the count values in a plurality of interference vectors having a predefined size. The predefined size the interference vectors may be the vector length and may be the number of elements each interference vector contains.

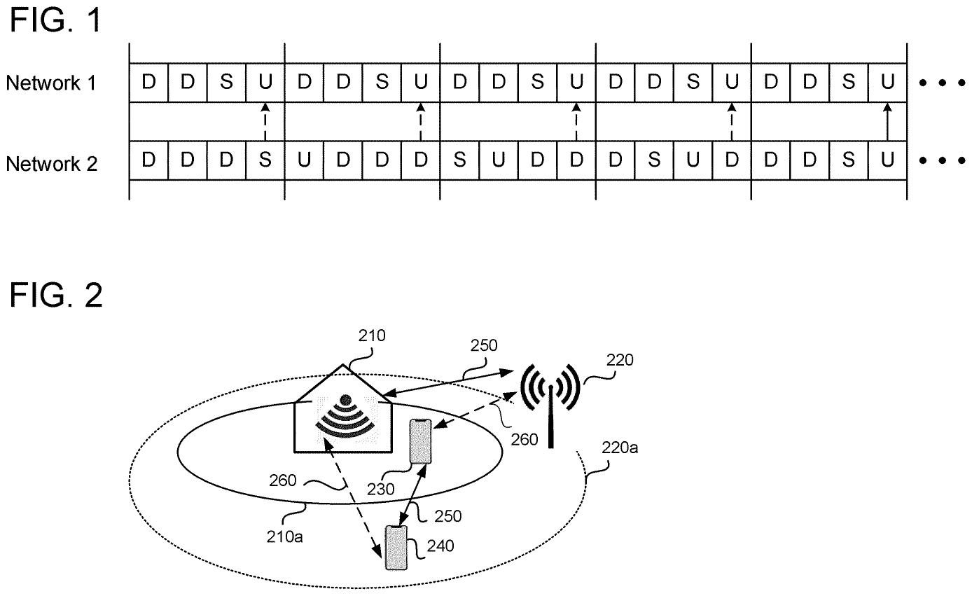

For example, the predefined size of the interference vectors is a multiple of the TDD pattern size for the interfered network, i.e. a multiple of the length of the TDD pattern for the interfered network. The length of the TDD pattern may be the number of TDD slots in the TDD pattern. For example, in FIG. 1, the length of the TDD pattern for network 1 is 4, whereas the length of the TDD pattern for network 2 is 5. This may be equivalent to set the size of the interference vector as a time window. In other words, the predefined size may be a multiple of the total number of TDD slots of the TDD pattern. For instance, if the TDD pattern has 4 TDD slots, the interference vector may have a size of 4, 8, 12, 16, or the like.

According to an example, the predefined size of the interference vectors may be obtained by using a least common multiple (LCM) between the length of the TDD pattern for the interfered network and a length of the TDD pattern for the interfering network. If there are two or more interfering networks, the LCM may be applied by considering or adding the length of all TDD patterns. If the network 1 of FIG. 1 is the interfered network and network 2 of FIG. 1 is the interfering network, the least common multiple of 4 (length of the TDD pattern for network 1) and 5 (length of the TDD pattern for network 2) is 20. Thus, the predefined size of the interfering vectors may be 20. By using LCM, ease of implementation and a fast process to determine an appropriate size of the interference vector is ensured.

However, the TDD pattern for the interfering network and, thus, the length of the TDD pattern for the interfering network is rarely known. In this case, a simple algorithm with the LCM logic explained above may be performed to quickly determine the size of the interference vector. Generally, the TDD patterns currently implemented may have a length between 4 to 10 TDD slots. However, also any other length may be possible. Thus, candidate sizes may be generated, wherein the predefined size may be selected from the candidate sizes. If it is assumed that the TDD pattern for the interfered network has, for example, 4 TDD slots, the candidate sizes may be obtained using LCM and all possible TDD pattern lengths for the interfering network: LCM(4,4)=4, LCM(4,5)=20, LCM(4,6)=12, LCM(4,7)=28, LCM(4,8)=8, LCM(4,9)=36, LCM(4,10)=20.

Thus, in this example, the candidate sizes may be 4, 8, 12, 20, 28, and 36. The predefined size of the interference vector may be set to any of the candidate sizes previously generated.

Then, a matrix may be created (step S430), wherein each interference vector may represent a row in the matrix. Thus, the number of columns of the matrix may be equal to the size of the interference vector. The number of rows of the matrix may be defined by number of samples in time, i.e. number or period of interference vectors in time.

Once a matrix is created, the count values may be summed up (step S440) per column of the matrix to obtain a sum value per column. The sum values may be organized (step S450) in a sum vector.

Moreover, the method may comprise identifying (step S460) a NACK occurrence pattern from the sum vector and determining (step S470) the interference pattern from the identified NACK occurrence pattern. Determining the interference pattern may comprise identifying or detecting the interference pattern from the identified NACK occurrence pattern, since the NACK occurrence pattern is highly correlated with an interference pattern.

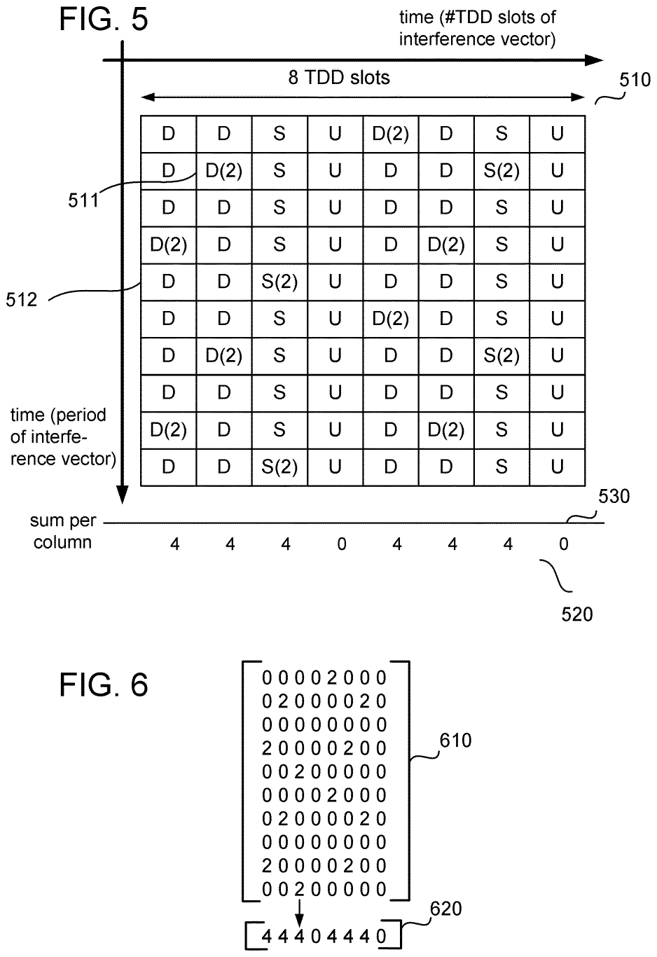

FIG. 5 shows an exemplary matrix 510 of NACK count samples with interference vector size of two times the TDD pattern size. The text in each cell of the matrix 510 denotes the slot direction (downlink, uplink, or special) and the counted number of NACK feedback occurrences. The letter “D” refers to a DL slot, the letter “U” refers to an UL slot, and the letter “S” refers to a special slot. In this example, the special slots are configured with 10 DL symbols and are hence treated as DL slots. For example, “D(2)” means two NACK feedback counts in a downlink slot, i.e. a count value of 2 for a downlink slot. “D” means no NACK count in a downlink slot, i.e. a count value of 0 for a downlink slot. This is the same for an uplink slot or a special slot.

In other words, the count value for each of the plurality of TDD slots is shown in brackets behind the TDD slot indication. For example, for TDD slot 511, the count value is 2. This means that 2 NACK feedbacks mapped to the TDD slots have been determined and the TDD slot 511 suffers interference. The count value may be any other number than 2 and may be different for each TDD slot.

For TDD slot 512, there is no value shown in brackets. Thus, the count value for this TDD slot is 0. This means that no NACK feedbacks mapped to TDD slot 512 have been determined and this TDD slot 512 does not suffer interference.

In FIG. 5, the TDD pattern of the interfered network is DDSU and, thus, comprises four TDD slots. Thus, the length or size of the TDD pattern is 4. Here, the TDD pattern of the interfering network is unknown. In this case, the predefined size the interference vectors is set to two times the length of the TDD pattern for the interfered network, resulting in interference vectors with a size of 8 TDD slots. This is, however, not limiting and the predefined size of the interference vectors can be set to any multiple of the length of the TDD pattern for the interfered network. It is also possible to generate candidate sizes as described above and selecting the predefined size from the candidate sizes.

The interference vectors are ordered to create the matrix 510, such that the matrix 510 has 8 columns (equal to the size of the interference vectors). The number of rows of the matrix 510 is equal to the number of interference vectors which are considered. In other words, the number of rows is equal to a certain period of interference vectors, e.g., 10 periods. The number of periods may be preset and may be less or more than 10.

To sum it up, in FIG. 5, no TDD slot suffers interference in the third and eight rows, only one TDD slot suffers interference in the first, fifth, sixth, and tenth rows, and two TDD slots suffer interference in the second, fourth, seventh, and nineth rows. As shown in FIG. 5, during multiple feedback periods of the interference vector, different TDD slots may arbitrarily suffer interference.

To obtain a sum vector 520, the count values may be summed up per column of the matrix 510. By summing up the count values per column of the matrix 510, a sum value per column is obtained which may then be organized in the sum vector 520. In FIG. 5, the sum values for the first to third and fifth to seventh columns are 4, whereas the sum values for the fourth and eight columns is 0. For simplicity, in the example of FIG. 5, the NACKs are added per slot for a certain period of interference vectors, e. g., 10 periods. However, it is also possible to weight the count values for each TDD slot using, for example, a forgetting factor, which is described in more detail below.

The sum values may be represented by a graph 530 which may, or may not, comprise peaks. In this case, the graph 530 is a horizontal line which does not comprise any peaks. The peaks will be described in more detail below.

Based on the sum vector 520 and/or the graph 530, it is not possible to identify a NACK occurrence pattern and, thus, it is also not possible to determine an interference pattern. The reason thereof is that out of the 8 TDD slots of the sum vector, 6 TDD slots have the same amount of sum values 4 with a sparse distribution in time. Thus, no peaks can be derived and no NACK occurrence pattern is visible.

FIG. 6 shows another representation of matrix 510 of FIG. 5. The matrix 610 shown in FIG. 6 corresponds to matrix 510, wherein the slot direction is no longer indicated in matrix 610. Only the count values for each TDD slot are presented in matrix 610. From the matrix 610, the sum vector 620 is determined, wherein the sum vector 620 is equal to the sum vector 520 illustrated in FIG. 5.

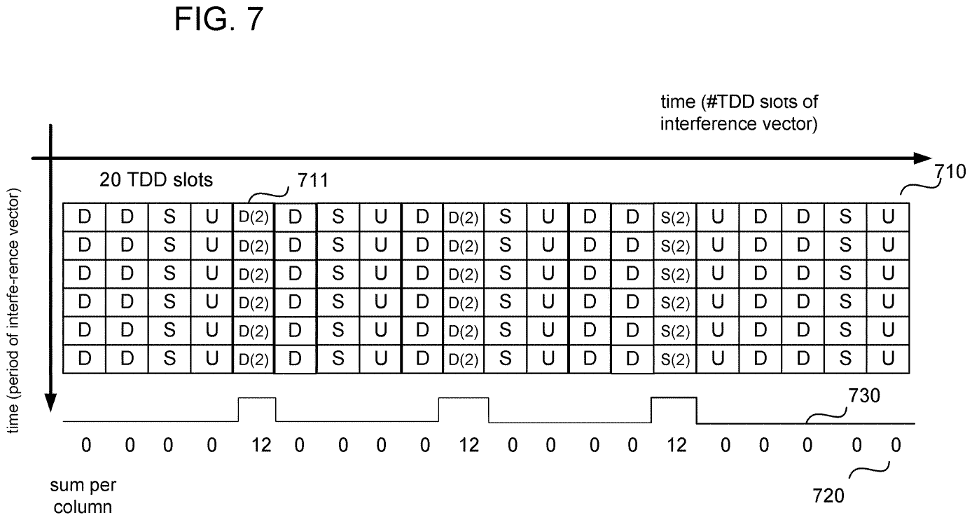

FIG. 7 shows an exemplary matrix of NACK count samples with interference vector size of five times the TDD pattern size. As will be shown below, by changing the size of the interference vectors to five times the length of the TDD pattern, i.e. to a size of 20 TDD slots, a clear NACK occurrence pattern can be identified, i.e. is visible, over multiple time periods (see the sum vector 720 with values greater than 0 distributed in time or the graph 730 having clear peaks). The NACK occurrence pattern may indicate that there is high likelihood that the interference has a pattern and, thus, an interference pattern can be determined. It is assumed that a failed reception is likely to occur due to interference.

A detailed description of the matrix 710 and its cells 711 is omitted at this point and it is referred to the explanation given with respect to matrix 510 shown in FIG. 5. Furthermore, it is referred to the explanation given with respect to the sum vector 520 in FIG. 5 in order to show how the sum vector 720 is obtained from the matrix 710.

As can be seen in FIGS. 7, 3 TDD slots of the sum vector 720 have a value much greater than 0. Furthermore, these 3 TDD slots are distributed in time. Thus, it is possible to identify a clear NACK occurrence pattern.

This is also shown with the graph 730 being another representation of the sum vector. The TDD slots having a value greater than 0 are represented as peaks, wherein the frequency and order of the peaks can be interpreted as a NACK occurrence pattern.

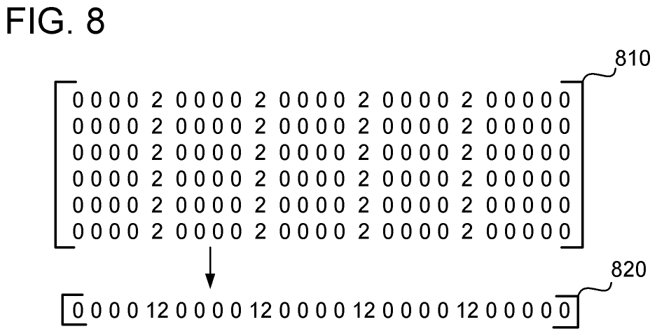

FIG. 8 shows another representation of the matrix of FIG. 7. The matrix 810 shown in FIG. 8 corresponds to matrix 710, wherein the slot direction is no longer indicated in matrix 810. Only the count values for each TDD slot are presented in matrix 810. From the matrix 810, the sum vector 820 may be determined, wherein the sum vector 820 is equal to the sum vector 720 illustrated in FIG. 7. For further details, we refer to the explanation given with respect to FIG. 7.

From this NACK occurrence pattern which is derived from the sum vector 720 or 820, an interference pattern may be determined, because the NACK occurrence pattern can be directly and clearly mapped to an interference pattern. Thus, an interference pattern can be accurately determined with high probability.

Furthermore, by using basic operations with vectors and matrices for determining the interference pattern, the processing complexity is kept low even for a large number of terminal devices and multiple coexisting networks. In addition, it is possible to select appropriate scheduling actions based on the determined interference pattern in order to reduce the effect of interference and improve the overall system performance. By reducing the effect of interference, more reliable transmissions without packet losses and retransmissions are ensured, leading to lower energy footprints for both terminal devices and network nodes.

According to an embodiment, different algorithms may be used to identify a NACK occurrence pattern from the sum vector and/or graph, for example, by detecting peaks in the sum vector or graph. The idea may be to detect clear peaks in the sum vector or graph which are occurring periodically or almost-periodically. These peaks may represent the NACK occurrence pattern. For example, machine learning, like trained neural networks or the like, image processing, analytical processing, and/or mathematical processing may be used to identify a NACK occurrence pattern from the sum vector. Widely used image processing methods may identify sparsity, edges and patterns within the sum vector based on matrix calculations. Based on matrix calculations which are often used in image or signal processing, it is possible to easily and quickly obtain edges, peaks, segments and/or patterns in the sum vector, thus speeding up the process of detecting an interference pattern.

According to another example, a NACK occurrence pattern may be identified using a threshold. The threshold may be predefined accordingly. A sum value of the sum vector exceeding the threshold may be identified as a peak, wherein a NACK occurrence pattern may be identified based on an arrangement of peaks over the sum vector. For example, the threshold may be set to 5, so that no peak is identified in the sum vectors 520 and 620, but peaks are identified in sum vectors 720 and 820. The threshold is not limited to 5 and may be set to any other value. Based on the peaks, the graphs 530 and 730 may be generated.

In the embodiments described above, all the count values are equally summed up in order to obtain the sum values. It is also possible to weight the count values over time. As the above-described method may be running in time, older feedback statistics and, thus, older NACK feedbacks may be given less weight compared to newer feedback statistics. This can be considered by implementing a forgetting functionality that depends on time which gives less importance to older NACK feedbacks.

For example, the forgetting functionality may be implemented by using a forgetting factor which may be used as a weighting factor. The count values may be multiplied with the forgetting factor for weighting the count values over time. The count values multiplied with the forgetting factor may then be summed up per column to obtain the sum value per column. The forgetting factor may be re-configurable, i.e. updated or modified, depending on, for example, changing circumstances or requirements.

The multiplication of the count values and the forgetting factor may be indicated by the following product, wherein the parameter FORGETTING_FACTOR represents the forgetting factor and the parameter NACK_COUNT represents the count value:

$$FORGETTING\_FACTOR \cdot NACK\_COUNT$$

For example, count values from the first number of rows of the matrix, i.e. older count values, may be multiplied with a smaller forgetting factor, whereas count values from subsequent rows, i.e. newer count values, may be multiplied with a higher forgetting factor. Thus, older feedback statistics have less impact on the sum values.

According to an embodiment, the forgetting factor may be obtained or determined by a function over time. The function and, thus, the forgetting factor, may converge to zero over time, resulting in older NACK feedbacks being multiplied with zero and, thus, having no impact on the sum values. Denoting NACK feedbacks as old may be flexibly defined based on a time window. Thus, the product FORGETTING_FACTOR·NACK_COUNT may eventually reach zero and the count values can be removed.

According to an embodiment, a moving time window may be considered. The duration of the moving time window may be flexibly selected. The interference vectors and matrices may only be built with count values when the NACK feedbacks are inside the moving time window. The moving time window may be a time window which moves, i.e. is updated, over time. The count values within the moving time window may be summed up per column to obtain the sum value per column. The count values which are outside of the moving time window may be omitted and may not be summed up for the sum value. Thus, older count values located outside the moving time window, i.e. older NACK feedbacks, may be omitted in the calculations for the sum values.

The above-described time windows may be configured in a flexible manner. For example, for more dynamic environments (e. g., factory shopfloor with moving machine parts, mobile robots, workers, etc.), the time window may be selected smaller compared to more static environments, such as an office building, etc.

According to another embodiment, NACK statistics may be complimented with acknowledgement (ACK) statistics. This may be useful to calibrate the NACK count statistics. For example, a number of ACK feedbacks mapped to each TDD slot is further used to determine the count value for each TDD slot.

For instance, the interference for a TDD slot with two NACK feedbacks may be different when eight ACK feedbacks or two ACK feedbacks are received in the same TDD slot. In order to also consider the number of ACK feedbacks for the count values, the count value for each TDD slot may be determined or calculated by dividing the number of NACK feedbacks by the total number of HARQ feedbacks per TDD slot, i.e. by the total number of NACK feedbacks and ACK feedbacks mapped to each TDD slot. Thus, the count value may be a value in the range of 0 to 1. Although the number of NACK feedbacks is the same in two TDD slots, the count values corresponding to the TDD slots may be different. For example, the count value is higher when less ACK feedbacks are received. This is shown in the subsequent example. When, for example, two NACK feedbacks and eight ACK feedbacks are received for one TDD slot, the count value for this TDD slot is 2/8 or 0.25. For another example, when two NACK feedbacks and two ACK feedbacks are received for one TDD slot, the count value for this TDD slot is 1.

It is also possible to consider further radio measurements and other key performance indicators (KPI) of the network per TDD slot to determine the count value and, thus, determine the interference pattern. For example, the KPI value mapped to each TDD slot is further used to determine the count value for each TDD slot. The KPI value may indicate at least one of a reference signal received power (RSRP), cross-link interference RSRP, channel state information (CSI), reference signal received quality (RSRQ), sounding reference signal received signal strength indicator (SRS-RSSI), signal to interference and noise ratio (SINR), and the like. To determine the count value for each TDD slot, the KPI value for each TDD slot may be summed up with the number of NACK feedbacks mapped to each TDD slot. The KPI value and the number of NACK feedbacks may be equally summed up to determine the count value or the KPI value may be multiplied to a weighting factor. By weighting the KPI value, the KPI value or the number of NACK feedbacks can be prioritized, i.e. weighted, differently.

According to an embodiment, the above-described method may further comprise a step of selecting a scheduling action, i.e. scheduling decision, for mitigating interference in the interfered network based on the determined interference pattern. The scheduling action may be performed by, for example, the network node or any other node operating or influencing the interfered network in order to reduce the interference in the network and, thus, improve system performance. For example, a scheduling action comprises link adaptation or the like to mitigate the interference in the interfered network.

The above-described method may further comprise receiving an identification information of at least one terminal device. The identification information may be used to map the NACK feedbacks to the at least one terminal device having transmitted the NACK feedbacks and indicating position information of the at least one terminal device. The scheduling action may be adapted based on the position information.

For example, when there is a plurality of terminal devices moving in the radio cells, i.e. in the networks, and across radio cells, i.e. across a plurality of networks, a larger set of statistics may be used with respect to the NACK feedbacks. For example, location data, i.e. the position information, from the terminal devices is collected from within the radio system or via external application interfaces. The count value can be conditioned to particular areas of the deployment as different areas within the networks may experience different interference situations due to proximity to neighboring, i.e. coexisting networks. Thus, the NACK occurrence pattern identification conditioned to deployment areas may provide a good approximation of the interference pattern experienced in different deployment areas within the networks. This information may be used to adapt the scheduling action based on different areas of the deployment.

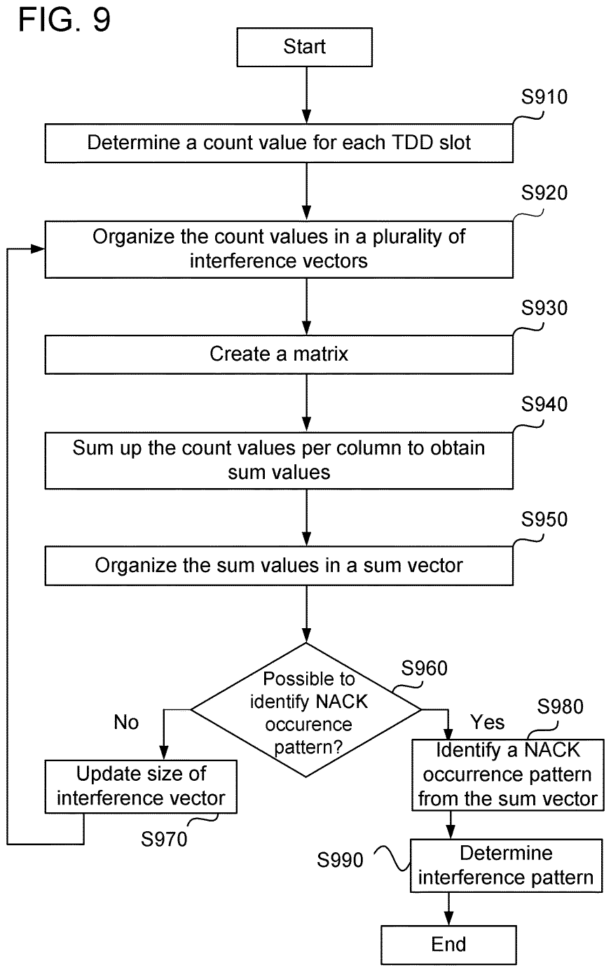

FIG. 9 shows an example of the previously described method with additional steps to further improve the interference pattern determination. It is noted that steps S910 to S950 of FIG. 9 are similar to steps S410 to S450 of FIG. 4 and are, thus, only briefly discussed with respect to FIG. 9. For more details, we refer to the explanation given with respect to FIG. 4.

As shown in FIG. 9, the method may comprise determining (step S910) a count value for each of a plurality of TDD slots based on a number of NACK feedbacks mapped to each TDD slot. The count values may be organized (step S920) in a plurality of interference vectors having a predefined size. As described above, the predefined size may be a multiple of a length of the TDD pattern for the interfered network and/or may be obtained by a least common multiple between the length of the TDD pattern for the interfered network and the length of the TDD pattern for the interfering network. The predefined size may be selected or defined from a set of candidate sizes which may indicate possible sizes for the interference vectors.

Once the count values are organized as the interference vectors, the method may comprise creating (step S930) a matrix, wherein each interference vector may represent a row in the matrix. Furthermore, the method may comprise summing up (step S940) the count values per column of the matrix to obtain a sum value per column and organizing (step S950) the sum values in a sum vector.

Subsequently, the method may comprise the step of determining (step S960) whether it is possible to identify a NACK occurrence pattern from the sum vector. As explained with respect to FIGS. 5 and 6, it is sometimes possible that no NACK occurrence pattern can be identified due to, for example, interference vectors having inappropriate sizes.

If no NACK occurrence pattern is identified (“No” in step S960), the method may proceed to step S970. For example, if it is determined that it is not possible to identify the NACK occurrence pattern from the sum vector after a predetermined time period, i.e. after a predetermined period of interference vectors, the predefined size of the interference vectors may be updated (step S970) and the steps for determining the NACK occurrence pattern may be repeated with the interference vectors having the updated predefined size. Updating the predefined size may comprise increasing the predefined size, decreasing the predefined size, or selecting another size from a set of possible sizes for the interference vectors. For example, if it is not possible to identify the NACK occurrence pattern using interference vectors with eight TDD slots (see FIGS. 5 and 6), the size of the interference vectors may be increased to 20 TDD slots (see FIGS. 7 and 8) and the count values are organized in the interference vectors with the new size of 20 TDD slots.

Thus, the method may decide based on previous and current statistics, distribution of the count values, and other aspects mentioned above whether it is required to update the number of columns of the matrix and, thus the vector length of the interference vectors in order to determine an interference pattern. If the algorithm is not able to identify an interference pattern, it may be requests to update the vector length and, thus, the number of columns of the matrix and the method may continue to collect NACK feedbacks, determine the count values, and continuously check the sum vector until a NACK occurrence pattern can be identified and an interference pattern can be determined.

Instead of or in addition to updating the number of columns of the matrix, it is also possible to update the number of rows of the matrix. This may be done by updating number of Samples in time, i.e. number or period of interference vectors in time.

If a NACK occurrence pattern is identified (“Yes” in step S960), the method may proceed to step S980. Similar to steps S460 and S470 of FIG. 4, a NACK occurrence pattern may be identified (S980) from the sum vector and the interference pattern may be determined (step S990) from the identified NACK occurrence pattern. When the interference pattern is determined, the interference pattern may be transmitted to network entities in charge of applying scheduling actions for mitigating the interference in the interfered network.

Thus, with the method according to FIG. 9, it is possible to automatically update the interference vectors and/or the matrices, in order to quickly determine an interference pattern with high probability.

According to an embodiment, different sizes of the interference vectors may be tried out in parallel. For example, the above-described method may be run in multiple parallel threads to quickly assess an appropriate size of the interference vectors and quickly determine the interference pattern. For this purpose, the count values may be organized in a plurality of first interference vectors having a first size and in a plurality of second interference vectors having a second size different from the first size. A first matrix may be created having the plurality of first interference vectors as rows and a second matrix may be created having the second interference vectors as rows. The first and second matrices may be created in parallel to run the method in multiple parallel threads.

The count values may be summed up per column of the first matrix to obtain the sum value per column and the sum values may be organized in a first sum vector. Similarly, the count values may be summed up per column of the second matrix to obtain the sum value per column and the sum values may be organized in the second sum vector.

When both the first sum vector and the second sum vector are obtained, it may be determined whether it is possible to identify the NACK occurrence pattern from the first sum vector or the second sum vector. If the NACK occurrence pattern can be identified from the first sum vector, the first size, the first sum vector, and its corresponding NACK occurrence pattern are used for determining the interference pattern. If, on the other hand, the NACK occurrence pattern can be identified from the second sum vector, the second size, the second sum vector, and its corresponding NACK occurrence pattern are used for determining the interference pattern. Thus, different sizes of the interference vectors can be tested in parallel in order to quickly determine the interference pattern.

Even though only two matrices are described above, it is also possible to create more than two matrices in parallel in order to speed up the process of determining an interference pattern. For instance, multiple matrices may be created for each LCM with the TDD pattern length of the interfered network and all possible TDD pattern lengths for the interfering network. As described above, the possible TDD pattern lengths for the interfering network may be between 4 and 10 TDD slots. For example, a total of seven matrices may be created in parallel in order to quickly find a NACK occurrence pattern. Note that this is not limiting and the TDD pattern length for the interfering network may be less than 4 or more than 10.

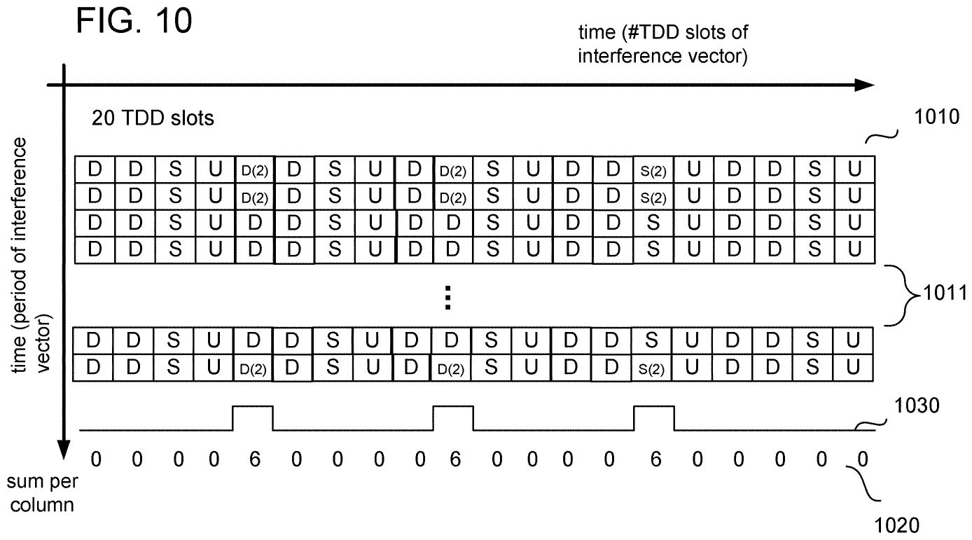

FIG. 10 shows an example of a matrix 1010 with interference vectors having a size of 20 TDD slots and non-continuous interference. A detailed explanation of the matrix 1010, the sum vector 1020, and the graph 1030 is omitted at this point and it is referred to FIGS. 5 and 7 and the explanations given with respect to matrices 510 and 710, the sum vectors 520 and 720, and the graphs 530 and 730 for conciseness reasons.

As shown in FIG. 10, the data transmission may be intermittent (see the gap 1011 in matrix 1010) and the interference may not affect all TDD slots. In this case, long term HARQ statistics, e. g. NACK feedbacks over a long time period, may be taken into account in order to determine the interference pattern of the interfered network. This may include multiple assessment intervals.

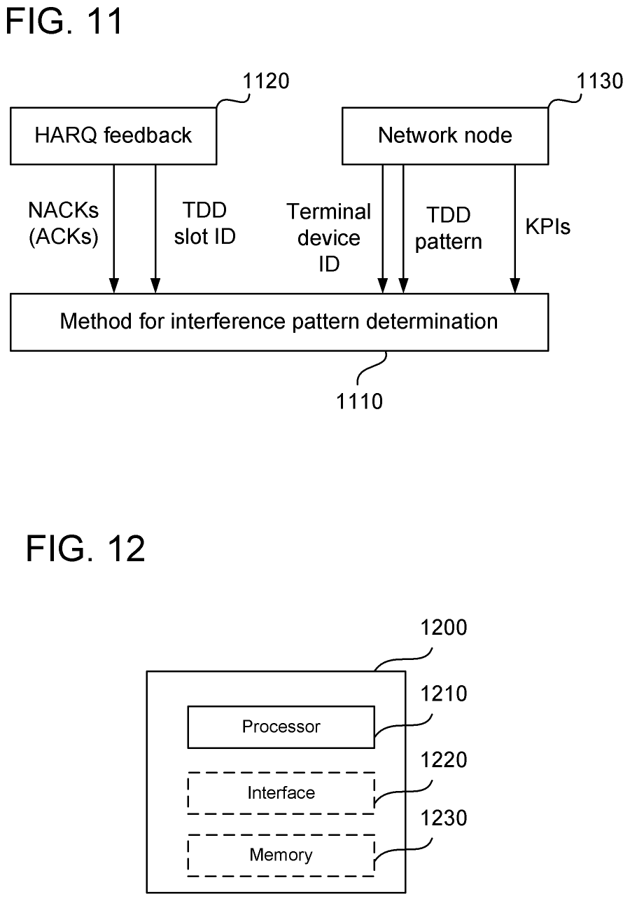

FIG. 11 shows an example of a simplified flowchart with feedbacks that can potentially be used for interference pattern determination. The method 1110 may be one of the methods described above in detail.

The HARQ feedback 1120 may provide the NACK feedbacks to the method 1110 which may be used for determining the count values for each TDD slot. Optionally, the HARQ feedback 1120 may also provide ACK feedbacks mapped to each TDD slot, wherein the ACK feedbacks may be used for determining the count values for each TDD slot. Moreover, the HARQ feedback 1120 may optionally provide TDD slot ID for mapping the NACK feedback and/or ACK feedback to the corresponding TDD slots.

A network node 1130 of, for example, the interfered network and/or interfering network may provide, as input to the method 1110, a terminal device ID for identifying, for example, the terminal device having transmitted the NACK and/or ACK feedbacks, a TDD pattern (e.g. number of uplink/downlink/special slots, total number of TDD slots in TDD pattern, etc.) of the interfered network and/or interfering network, KPIs, or the like. The inputs from the network node 1130 may be used to adapt the count values, create interference vectors with adequate size, select appropriate scheduling actions depending on, for example, the position of the terminal devices, or the like. Thus, the interference pattern can be accurately determined with high probability and the interference can be reduced for improved system performance.

FIG. 12 shows exemplary hardware of a node 1200 for determining an interference pattern in an interfered network operating in a TDD mode. The node may perform one of the methods described above for determining the interference pattern. The hardware may use software to implement the functions and methods described herein. As can be seen in FIG. 12, the optional components are shown with dashed lines. The node 1200 may comprise a processor 1210 and, optionally, an interface 1220 and/or a memory 1230. The interface 1220 may be used to communicate with other nodes and/or terminal devices. The memory 1230 may comprise instructions executable by the processor 1210.

According to an embodiment, the node 1200 may be a network node operating the interfered network or a cloud node.

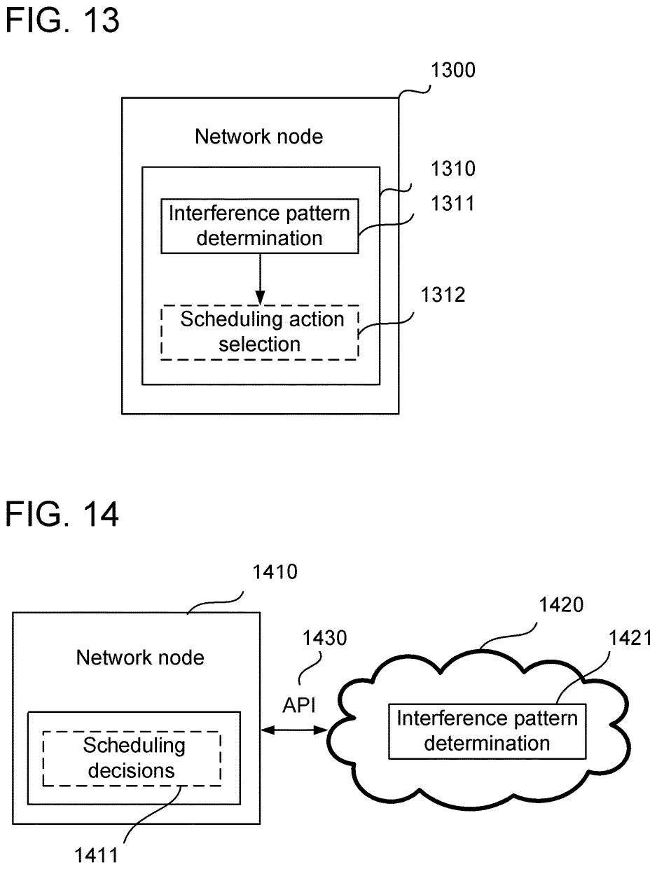

FIG. 13 shows an example where the node 1200 is a network node 1300 operating the interfered network. The network node 1300 may perform a method 1310 for determining the interference pattern (see box 1311). The method 1310 may be equal to the methods described above for determining the interference pattern. The methods may be an implementation in the baseband unit.

Optionally, the network node 1300 may further select a scheduling action (see box 1312 with dashed lines) based on the determined interference pattern. The scheduling action may be selected for mitigating the interference in the interfered network.

FIG. 14 shows an example where the node 1200 is a cloud node 1420. As shown in FIG. 14, the interference pattern determination may be moved to the cloud where the required information may be exposed to a core network. Thus, it is possible to offload the above-described methods in a cloud implementation based on an application programming interface (API). Moreover, the result of the interference pattern determination may serve as input for other cloud implementations (or APIs) in charge of performing actions, like scheduling actions, in the interfered network to improve the quality of service and enhance the performance of the interfered network.

As shown in FIG. 14, the cloud node 1420 may perform a method 1421 to determine the interference pattern. The cloud node 1420 may transmit the determined interference pattern to a network node 1410 operating the interfered network using an API 1430. Based on the received interference pattern, the network node 1410 may optionally (see box 1411 with dashed lines) select a scheduling action for mitigating the interference in the interfered network.

Alternatively, the cloud node 1420 may select a scheduling action for mitigating the interference in the interfered network based on the determined interference pattern and transmit the scheduling action to the network node 1410 using the API 1430. In this case, the network node 1410 does not have to select the scheduling action but solely needs to execute the scheduling action, leading to reduced processing load on the network node side. The cloud node 1420 may adapt the scheduling action based on position information of at least one terminal device having transmitted the NACK feedbacks (see explanation given above), wherein the position information may be derived from an identification information (ID) of the at least one terminal device.

Summing up, a method and node are proposed for determining count values for each TDD slot based on NACK feedbacks, organizing the count values in interference vectors, creating a matrix from the interference vectors, summing up the count values per column to provide a sum vector, and determining an interference pattern using the sum vector. Based on continuous measurements of current and past HARQ statistics, it is possible to accurately identify the interference pattern for unknown neighbor TDD frame structures.

Furthermore, by using basic operations with vectors and matrices for determining interference pattern, the processing complexity is low even for large number of terminal devices or coexisting networks.

Once the interference pattern is determined, different scheduling actions can be selected based on the determined interference pattern to reduce the effect of interference and improve system performance. Having more reliable transmissions without packet losses and retransmissions may lead to lower energy footprint for both terminal devices and network nodes. In other words, spectrally efficient transmissions are achieved, thereby improving the system capacity of coexisting networks.

There is generally considered a computer program product comprising instructions adapted for causing processing and/or control circuitry to carry out and/or control any method described herein with regard to the node, in particular when executed on the processing and/or control circuitry. Also, there is considered a carrier medium arrangement carrying and/or storing a computer program product as described herein.

It will be apparent to those skilled in the art that various modifications and variations can be made in the entities and methods of this invention as well as in the construction of this invention without departing from the scope or spirit of the invention.

The invention has been described in relation to particular embodiments and examples which are intended in all aspects to be illustrative rather than restrictive. Those skilled in the art will appreciate that many different combinations of hardware, software and/or firmware will be suitable for practicing the present invention.

Moreover, other implementations of the invention will be apparent to those skilled in the art from consideration of the specification and practice of the invention disclosed herein. It is intended that the specification and the examples be considered as exemplary only. To this end, it is to be understood that inventive aspects lie in less than all features of a single foregoing disclosed implementation or configuration. Thus, the true scope and spirit of the invention is indicated by the following claims.

1. A method for determining an interference pattern in an interfered network operating in a time division duplexing, TDD, mode, the method comprising:
determining a count value for each of a plurality of TDD slots based on a number of non-acknowledgement, NACK, feedbacks mapped to each TDD slot;
organizing the count values in a plurality of interference vectors having a predefined size;
creating a matrix each interference vector representing a row in the matrix;
summing up the count values per column of the matrix to obtain a sum value per column and organizing the sum values in a sum vector; and
identifying a NACK occurrence pattern from the sum vector; and determining the interference pattern from the identified NACK occurrence pattern.

2. The method according to claim 1, wherein, for each TDD slot, the NACK feedbacks are summed up to determine the count value.

3. The method according to claim 1, wherein the predefined size of the interference vectors is a multiple of a length of a TDD pattern for the interfered network.

4. The method according to claim 3, wherein the predefined size of the interference vectors is obtained by using a least common multiple between the length of the TDD pattern for the interfered network and a length of a TDD pattern for an interfering network.

5. The method according to claim 1, further comprising:
determining whether it is possible to identify the NACK occurrence pattern from the sum vector, wherein if it is determined that it is not possible to identify the NACK occurrence pattern from the sum vector after a predetermined time period, the predefined size of the interference vectors is updated and the steps for determining the NACK occurrence pattern are repeated with the interference vectors having the updated predefined size.

6. (canceled)

7. The method according to claim 1, wherein the count values are multiplied with a forgetting factor for weighting the count values over time; and
the count values multiplied with the forgetting factor are summed up per column to obtain the sum value per column.

8. The method according to claim 7, wherein the forgetting factor is obtained by a function over time.

9. The method according to claim 1, wherein the count values within a moving time window are summed up per column to obtain the sum value per column.

10. The method according to claim 1, wherein a number of acknowledgement, ACK, feedbacks mapped to each TDD slot is further used to determine the count value for each TDD slot.

11. The method according to claim 10, wherein the count value for each TDD slot is determined by dividing the number of NACK feedbacks by the total number of NACK feedbacks and ACK feedbacks mapped to each TDD slot.

12. (canceled)

13. (canceled)

14. The method according to claim 1, wherein the count value for each TDD slot is determined by summing up the KPI value and the number of NACK feedbacks mapped to each TDD slot.

15. The method according to claim 14, wherein the KPI value is multiplied to a weighting factor.

16. (canceled)

17. The method according to claim 1, further comprising receiving an identification information of at least one terminal device, the identification information being used to map the NACK feedbacks to the at least one terminal device having transmitted the NACK feedbacks and indicating position information of the at least one terminal device, wherein the scheduling action is adapted based on the position information.

18. The method according to claim 1, further comprising receiving the NACK feedbacks in a specific time window.

19. The method according to claim 18, wherein the specific time window is determined based on a subcarrier spacing, SCS.

20. (canceled)

21. The method according to claim 1, wherein the NACK occurrence pattern is identified using a threshold, wherein a sum value exceeding the threshold is identified as a peak and a NACK occurrence pattern is identified based on an arrangement of peaks over the sum vector.

22. The method according to claim 1, further comprising organizing the count values in a plurality of first interference vectors having a first size and organizing the count values in a plurality of second interference vectors having a second size different from the first size;
creating a first matrix having the plurality of first interference vectors as rows and creating a second matrix having the second interference vectors as rows;
summing up the count values per column of the first matrix to obtain the sum value per column and organizing the sum values in a first sum vector;
summing up the count values per column of the second matrix to obtain the sum value per column and organizing the sum values in the second sum vector; and
determining whether it is possible to identify the NACK occurrence pattern from the first sum vector or the second sum vector.

23. (canceled)

24. A node for determining an interference pattern in an interfered network operating in a time division duplexing, TDD, mode, the node configured to:
determine a count value for each of a plurality of TDD slots based on a number of non-acknowledgement, NACK, feedbacks mapped to each TDD slot;
organize the count values in a plurality of interference vectors having a predefined size;
create a matrix, each interference vector represents representing a row in the matrix;
sum up the count values per column of the matrix to obtain a sum value per column and organize the sum values in a sum vector;
identify a NACK occurrence pattern from the sum vector; and
determine the interference pattern from the identified NACK occurrence pattern.

25. The node according to claim 24, wherein, for each TDD slot, the NACK feedbacks are summed up to determine the count value.

26. (canceled)

27. The node according to claim 24, wherein the node is a cloud node.

28-41. (canceled)
